(19) United States
(12) Patent Application Publication
(10) Pub. No.: US 2002/0141413 A1
(43) Pub. Date: Oct. 3, 2002

(54) Data reduced data stream for transmitting a signal

(75) Inventor: Helmut Schlaegl, Vienna (AT)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 10/105,496

(22) Filed: Mar. 25, 2002

(30) Foreign Application Priority Data
Mar. 29, 2001 (EP) 01 890 105.8

(51) Int. Cl. H04L 12/28

(52) U.S. Cl. 370/394; 370/389

(57) ABSTRACT

A data stream (DC) for transmitting a signal, which data stream is produced by means of a compression method and includes time-sequential data packets (DP1, DP2), which data packets (DP1, DP2) each represent a signal portion which appears during a time interval, includes combination data packets (KP) which are each intended for the representation of two time-sequential data packets (DP1, DP2).

The invention relates to a data stream for transmitting a signal, which data stream is derived from the signal by the use of a compression method and which data stream includes time-sequential data packets which each represent a signal portion appearing during a time interval.

The invention further relates to an output apparatus for a data stream, which data stream is derived from the signal by the use of a compression method, the output apparatus having a data source adapted to generate and to supply data packets which each represent a signal portion appearing during a time interval and which each have an amount of data, and having data reduction means adapted to reduce the amount of data, and having output means for the output of the data stream by the output apparatus.

The invention further relates to a data reduction method for reducing an amount of data required for transmitting a signal, which method includes the following steps, namely receiving data packets, which data packets each represent a signal portion appearing during a time interval and which each have an amount of data, and reducing the amount of data.

The invention further relates to a reproduction apparatus adapted to reproduce a signal which can be received with the aid of a data stream, which data stream is derived from the signal by the use of a compression method, the reproduction apparatus having receiving means adapted to receive the data stream, and having signal reconstruction means adapted to reconstruct the signal from the data stream by the use of a decompression method, and having reproducing means adapted to reproduce the reconstructed signal.

The invention further relates to a signal reconstruction method for reconstructing a signal from a data stream, which data stream is derived from the signal by the use of a compression method, which signal reconstruction method includes the following step, namely reconstructing the signal from the data stream by the use of a decompression method.

The invention further relates to a data reduction circuit for reducing an amount of data required for transmitting a signal, the circuit having an input terminal via which the data reduction circuit can receive data packets which each represent a signal portion appearing during a time interval, and having data reduction means adapted to reduce the amount of data, and having an output terminal via which the data reduction circuit can supply a representation of the received data packets.

The invention further relates to a signal reconstruction circuit for the reconstruction of a signal from a data stream, which data stream is derived from a signal by the use of a compression method, the signal reconstruction circuit having an input terminal via which the data stream data stream can be applied to the signal reconstruction circuit, and having signal reconstruction means adapted to reconstruct the signal from the data stream by the use of a decompression method, and having an output terminal via which the signal reconstruction circuit can supply the reconstructed signal.

A data stream of the type defined in the first paragraph is used in conjunction with a commercially available output apparatus of the type defined in the second paragraph, which output apparatus includes a data reduction circuit of the type defined in the third paragraph and which output apparatus is adapted to carry out a data reduction method of the type defined in the third paragraph, and in conjunction with a commercially available reproduction apparatus of the type defined in the fourth paragraph, which reproduction apparatus includes a signal reconstruction circuit of the type defined in the seventh paragraph and which reproduction apparatus is adapted to carry out a signal reconstruction method of the type defined in the fifth paragraph, so that both the data stream, the output apparatus, the data reduction method, the reproduction apparatus, the signal reconstruction method, the data reduction circuit and the signal reconstruction circuit are known.

The known output apparatus is a conventional personal computer (PC). The PC includes a compact disc playing device, which forms a data source and which is adapted to transmit an MPEG 1 Layer 3 (MP3) compressed signal to a motherboard of the PC as MP3 encoded data packets, the signal representing a piece of music. The data packets include an amount of data optimized for a high signal quality. The known reproduction apparatus is a portable audio playing apparatus, particularly RUSH1, having the type designation SA100, which has a semiconductor memory of limited memory capacity, with the aid of which pieces of music can be stored for subsequent reproduction. The motherboard of the PC forms a data reduction circuit. The PC further includes data reduction means for reducing the amount of data of the MP3 encoded data packets. The data reduction means are realized with the aid of transcoder software, which can be processed with the aid of the motherboard and which is employed to transcode, i.e. to decompress, the MP3 encoded data packets so as to reconstruct the signal, and to MP3 compress the reconstructed signal again with a correspondingly higher compression rate so as to generate MPR recompressed data packets whose amount of data is optimized for the memory capacity of the audio playing apparatus, so as to allow a maximal number of pieces of music to be stored in the semiconductor memory of the audio playing apparatus. The MP3 encoded data packets can be transmitted from the motherboard to a USB output module of the PC, which forms output means for supplying the piece of music. A time sequence of the supplied MP3 encoded data packets form the known data stream for the transfer of the piece of music between the PC and the audio playing apparatus. The audio playing apparatus has a USB input module, which forms receiving means and which is adapted to receive the data stream and to store the data stream in the semiconductor memory. The USB input module is connected to a processor board which forms a signal reconstruction circuit, by means of which decompression software, which forms signal reconstruction means, can be processed. With the aid of the decompression software the MP3 encoded data packets stored in the semiconductor memory during the transfer are decompressed and the piece of music is thus reconstructed. The piece of music thus reconstructed is supplied from the processor to the reproduction means, which are basically formed with the aid of an amplifier and a loudspeaker. A problem of the output apparatus is that transcoding requires a substantial amount of computing power and memory resources, as a result of which the user will be confronted with undesirable additional transcoding delays during the transmission of the signal at a normal transmission rate. Another considerable problem is that during transcoding of the MP3 encoded data packets, which data packets already form a signal representation which exhibits a loss of signal quality, a further loss of signal quality has to be taken into the bargain. Therefore, the data stream has the problem that it is only suited for the transmission of a signal having a low signal quality. Moreover, the reproduction apparatus exhibits the problem that it is merely adapted to reconstruct the signal on the basis of the received problematic data stream.

It is an object of the invention to solve the aforementioned problems with a data stream of the type defined in the first paragraph, and with an output apparatus of the type defined in the second paragraph, and with a data reduction method of the type defined in the third paragraph, and with a reproduction apparatus of the type defined in the fourth paragraph, and with a signal reconstruction method of the type defined in the fifth paragraph, and with a data reduction circuit of the type defined in the sixth paragraph, and with a signal reconstruction circuit of the type defined in the seventh paragraph, and to provide an improved output apparatus, and an improved data reduction method, and an improved reproduction apparatus, and an improved signal reconstruction method, and an improved data reduction circuit, and an improved signal reconstruction circuit.

According to the invention, in order to achieve the aforementioned object with a data stream of the type defined in the first paragraph, the data stream includes combination data packets which are each intended for the representation of at least two time-sequential data packets.

According to the invention, in order to achieve the aforementioned object with an output apparatus of the type defined in the second paragraph, the data reduction means take the form of combination means which are adapted to combine at least two time-sequential data packets to a combination data packet and to supply time-sequential combination data packets to the output means.

According to the invention, in order to achieve the aforementioned object with a data reduction method of the type defined in the third paragraph, during the reduction of the amount of data at least two time-sequential data packets are combined to a combination data packet.

According to the invention, in order to achieve the aforementioned object with a reproduction apparatus of the type defined in the fourth paragraph, the signal reconstruction means are adapted to reconstruct the signal from the combination data packets included in the data stream, which combination data packets are each intended for the representation of at least two time-sequential data packets which can be generated by the use of the compression method, each data packet representing a signal portion which appears during a time interval.

According to the invention, in order to achieve the aforementioned object with a signal reconstruction method of the type defined in the fifth paragraph, the signal is reconstructed from the combination data packets included in the data stream, which combination data packets are each intended for the representation of at least two time-sequential data packets which can be generated by the use of the compression method, each data packet representing a signal portion which appears during a time interval.

According to the invention, in order to achieve the aforementioned object with a data reduction circuit of the type defined in the sixth paragraph, the data reduction means take the form of combination means which are adapted to combine at least two time-sequential data packets to a combination data packet and to supply time-sequential combination data packets as a representation of the received data packets.

According to the invention, in order to achieve the aforementioned object with a signal reconstruction method of the type defined in the seventh paragraph, the signal reconstruction means are adapted to reconstruct the signal from the combination data packets included in the data stream, which combination data packets are each intended for the representation of at least two time-sequential data packets which can be generated by the use of the compression method, each data packet representing a signal portion which appears during a time interval.

By providing the measures in accordance with the invention it is advantageously achieved that a data-reduced data stream made up of combination data packets can be generated and supplied with the aid of the output apparatus, each combination data packet comprising an amount of data which is substantially smaller than a total amount of data of the data packets to be represented. A further advantage of the output apparatus is obtained in that additional delays during the generation of the data stream are avoided because transcoding, which demands much time, computing power and memory capacity, is dispensed with. Another major advantage is obtained in that the output apparatus can generate the data-reduced data stream without any significant additional deterioration in signal quality. Moreover, the advantage is obtained that the signal can be reconstructed from such a data stream with the aid of the reproduction apparatus. For the reproduction apparatus this further has the advantage that the signal can be reconstructed with a signal quality which substantially corresponds to the signal quality of the signal represented by means of the data packets. Furthermore, the advantage is obtained that the data-reduced data stream can be transmitted rapidly from the output apparatus to the reproduction apparatus.

With a data stream in accordance with the invention it has further proved to be advantageous when the combination data packets include combination data obtained by combining mutually corresponding useful data of at least two time-sequential data packets, and the combination data packets include reconstruction data obtained by the use of the at least two time-sequential data packets and adapted to reconstruct the signal from the combination data packets.

This has the advantage that the reconstruction data required for the reconstruction of the signal from the combination data are already included in the combination data packets and that the amount of data of the reconstruction data is only a fraction of the amount of data of each combination data packet. Furthermore, this has the advantage that during the transmission of the signal the reconstruction data included in addition to the combination data produce hardly any additional delay.

With a data stream in accordance with the invention it has further proved to be advantageous when the combination data include amplitude combination data which represent amplitude combination values, which amplitude combination values are obtained by combining mutually corresponding amplitude values, the corresponding amplitude values being represented with the aid of the mutually corresponding useful data of the at least two time-sequential data packets.

This has the advantage that during combining of the corresponding useful data of the at least two time-sequential data packets a frequency resolution of the signal obtained with the aid of each data packets is preserved during combining of the data packets and that only the amount of data required for the representation of the amplitude values is reduced.

In a data stream in accordance with the invention the amplitude combination values may represent geometric mean values of the amplitude values which correspond to each other. However, it has proved to be particularly advantageous if the amplitude combination values represent arithmetic mean values of the mutually corresponding amplitude values.

This has the advantage that undesirable psychoacoustic effects are avoided because allowance has been made for the hearing characteristic of the human organ of hearing in due proportion.

In a data stream in accordance with it has further proved to be advantageous when the combination data include frequency data included in at least two time-sequential data packets.

This has the advantage that the data stream includes the frequency information of the combined data packets without any change and that, consequently, a reconstruction of the signal with an optimum spectral resolution is guaranteed.

In a data stream in accordance with the invention it has further proved to be advantageous when the reconstruction data include amplitude reconstruction data adapted to reconstruct the signal amplitudes of at least two signal portions of the signal, which signal portions are represented with the aid of at least two time-sequential data packets.

This has the major advantage that with the aid of the data stream the dynamic signal response represented with the aid of each data packet can be reconstructed from the combination data packet during the reconstruction of the signal.

In a data stream in accordance with the invention it has further proved to be advantageous when the reconstruction data include frequency-band dependent amplitude reconstruction data adapted to reconstruct a signal amplitude in a frequency-band dependent manner.

This has the advantage that the data stream also enables the use of a frequency-band oriented grouping of the amplitude reconstruction data, as a result of which allowance can be made for, particularly, psychoacoustic effects during the generation of the data stream and during the reconstruction of the signal.

In a data stream in accordance with the invention it has further proved to be advantageous when the reconstruction data include frequency band dependent amplitude reconstruction data adapted to reconstruct at least one frequency band, which at least one frequency band corresponds to the frequency band dependent amplitude reconstruction data.

This has the advantage that in the case of a variable number of frequency bands as well as in the case of variable frequency bands an unambiguous allocation can be guaranteed between frequency-band dependent amplitude reconstruction values and the relevant frequency bands.

In a data stream in accordance with the invention it has further proved to be advantageous when the reconstruction data include amplitude reconstruction data adapted to reconstruct the mutually corresponding amplitude values of the at least two time-sequential data packets from the amplitude combination values.

This has the advantage that the relevant data packets can be reproduced unambiguously with the aid of the data stream. Moreover, it has the advantage that after the reconstruction of the data packets the signal can be reconstructed directly from the data packets by decompression of the data packets in the reproduction apparatus.

In a data stream in accordance with the invention it has further proved to be advantageous when the reconstruction data include time interval reconstruction data adapted to reconstruct the time intervals of the at least two signal portions of the signal, which at least two signal portions are represented with the aid of the at least two data packets represented by the combination data packet.

This has the advantage that signal portions of a signal to be reconstructed with the aid of the data stream can each have a variable length of time.

In a data stream in accordance with the invention it has further proved to be advantageous when the combination data packets include combination information data and when the combination information data include the reconstruction data.

This has the advantage that the combination data packets include combination data which are free from reconstruction data.

In a data stream in accordance with the invention it has further proved to be advantageous when the combination information data include identification data adapted to identify a combination data packet.

This has the advantage that combination data packets can be identified unambiguously.

In a data stream in accordance with the invention it has further proved to be advantageous when the amplitude reconstruction data represent signal energy content values, each signal energy content value representing an energy content of a signal portion of the signal, which signal portion is represented by one of the at least two data packets.

This has the advantage that for the reconstruction of the signal amplitude of the signal amplitude reconstruction data are available which enable the signal to be reconstructed in an optimum manner for the relevant signal portion.

In a data stream in accordance with the invention it has further proved to be advantageous when the signal energy content value of a signal portion of the signal is formed as a sum value of amplitude values, which amplitude values are represented with the aid of the useful data of the respective data packet.

This has the advantage that the signal energy content value can be computed in the simplest possible manner and that this requires hardly any computing power, as a result of which the computation can be effected rapidly, as is desired by a user.

The invention will now be described in more detail, by way of example, with reference to three embodiments which are shown in the drawings but to which the invention is not limited.

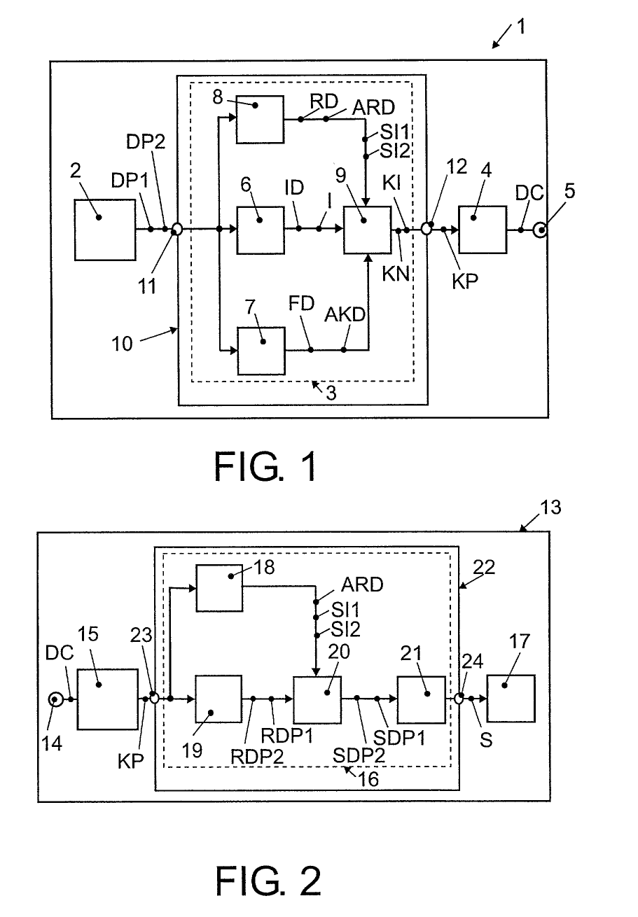

FIG. 1 is a block diagram which diagrammatically shows an output apparatus in accordance with a first embodiment of the invention.

FIG. 2 is a block diagram which diagrammatically shows a reproduction apparatus in accordance with the first embodiment of the invention.

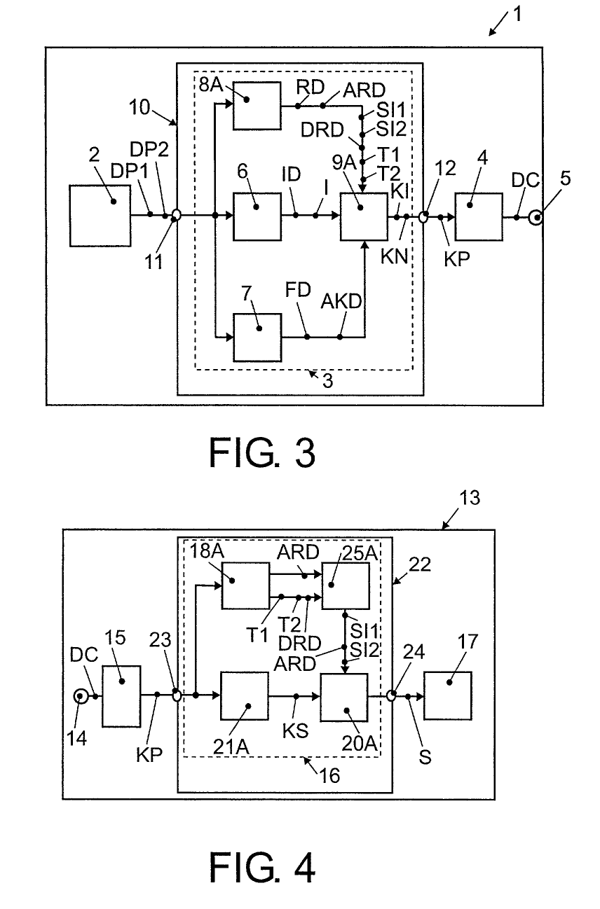

FIG. 3 is a block diagram which diagrammatically shows an output apparatus in accordance with a second embodiment of the invention.

FIG. 4 is a block diagram which diagrammatically shows a reproduction apparatus in accordance with the second embodiment of the invention.

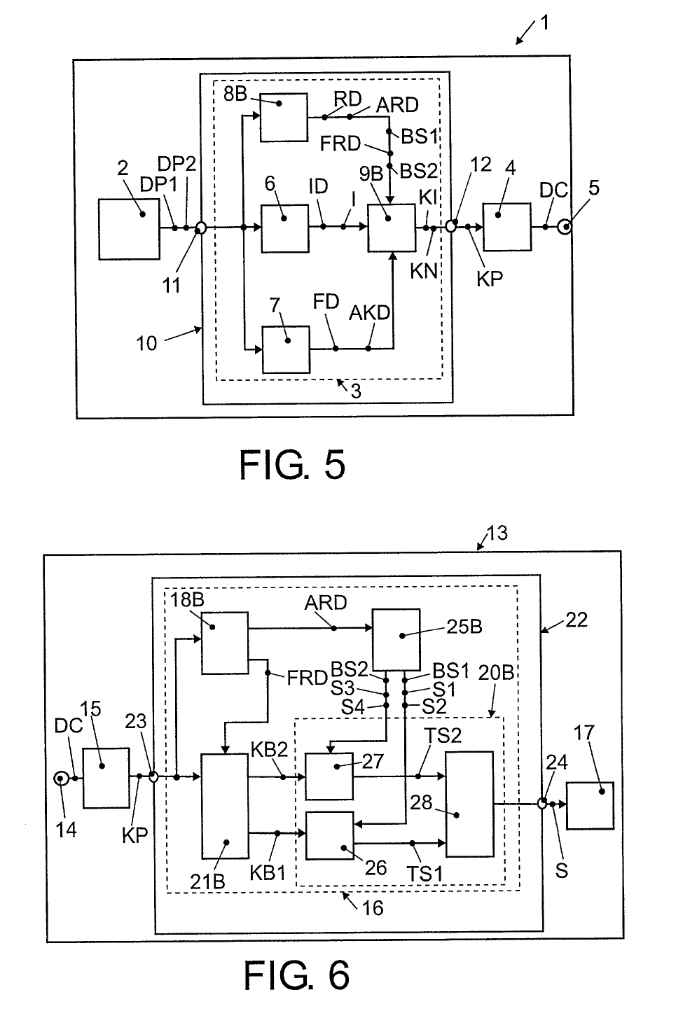

FIG. 5 is a block diagram which diagrammatically shows an output apparatus in accordance with a third embodiment of the invention.

FIG. 6 is a block diagram which diagrammatically shows a reproduction apparatus in accordance with the third embodiment of the invention.

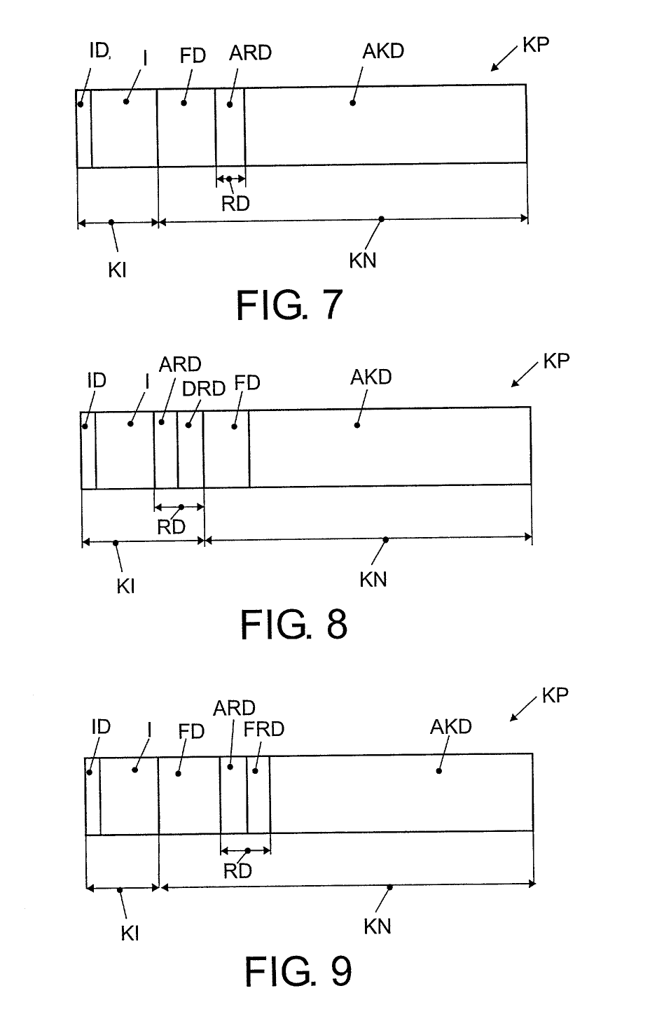

FIG. 7 diagrammatically shows a combination data packet in accordance with the first embodiment of the invention.

FIG. 8 diagrammatically shows a combination data packet in accordance with the second embodiment of the invention.

FIG. 9 diagrammatically shows a combination data packet in accordance with the third embodiment of the invention.

FIG. 1 shows an output apparatus 1 for a data stream DC, which apparatus takes the form of a conventional personal computer (PC). The output apparatus 1 includes a data source 2, combination means 3, output means 4 and an output terminal 5.

The data source 2 is realized with the aid of a compact disc playing device, which can play a compact disc (CD) on which a signal has been recorded with the aid of a compression method in accordance with the MPEG3 Layer 1 standard, briefly referred to as MP3, which signal represents a piece of music. When such a CD is played the data source 2 can generate a time sequence of so-called MP3 encoded data packets and supply said sequence to the combination means 3, FIG. 1 showing only two time sequential adjacent data packets, i.e. a first data packet DP1 and a second data packet DP2. In this context it is to be noted that the data source 2 may alternatively be realized with the aid of a hard disk, which can store the MP3 encoded data packets.

The first data packet DP1 represents a signal portion which appears in a first time interval. The second data packet DP2 represents a signal portion which appears in a second time interval, the second time interval having the same length as the first time interval. The data packets DP1 and DP2 form a comparatively large amount of data because a comparatively low compression rate is used during the compression process in order to enable a maximal signal quality to be achieved during a reconstruction of the signal. The data packets DP1 and DP2 have a header, by means of which information data are formed. The information data represent, inter alia, information relating to a bit rate chosen during the compression process and copyright information as well as a data format chosen during the compression process. The data packets further include useful data. The useful data essentially represent the result of a Fourier analysis performed for the relevant signal portion during the compression process. Thus, the useful data include frequency data, which frequency data represent the frequency values of the spectral analysis during the signal portion taken into consideration during the compression process. The useful data further include amplitude data representative of the amplitude values corresponding to the relevant frequency values.

The combination means 3 include information data generation means 6, combination data generation means 7, first reconstruction data generation means 8 and first joining means 9.

The combination means 3 are realized with the aid of combination software, which can be processed with the aid of the motherboard of the personal computer, which motherboard forms a data reduction circuit when the combination software is processed. The data reduction circuit 10 is adapted to reduce an amount of data required for transmitting a signal and has an input terminal 11 via which the data packets DP1 and DP2 can be applied from the data source 2 to the data reduction circuit 10. The data reduction circuit 10 further has an output terminal 12, via which a representation of the applied data packets DP1 and DP2 can be applied from the data reduction circuit 10 to the output means 4.

The data packets DP1 and DP2 received from the data source 2 with the aid of the input terminal 11 can be applied to the combination means 3, which are adapted to combine the two time sequential data packets DP1 and DP2 to a combination data packet KP and to supply the combination data packet KP as a representation of the applied data packets DP1 and DP2 to the output means 4 via the output terminal 12. Thus, with the aid of the data reduction circuit 10, i.e. with the aid of the combination means 3, the output apparatus 1 is adapted to carry out a data reduction method for reducing an amount of data required for transmitting a signal, which data reduction method includes the following steps, namely receiving the data packets DP1 and DP2 from the data source 2 and reducing the amount of data of the data packets DP1 and DP2, during which reduction of the amount of data of the data packets DP1 and DP2 at least two time sequential data packets DP1 and DP2 are combined to a combination data packet KP.

The combination data generation means 7 are adapted to combine mutually corresponding useful data of the two time sequential data packets DP1 and DP2, frequency data being extracted from the first data packet DP1 and being supplied as frequency data FD to the first joining means 9. The combination data generation means 7 are further adapted to generate amplitude combination data AKD and to supply the amplitude combination data AKD to the first joining means 9. The amplitude combination data AKD represent amplitude combination values, which can be generated by combining amplitude values which correspond to one another in frequency, the corresponding amplitude values being represented with the aid of the useful data of corresponding frequency of the two time sequential data packets DP1 and DP2. In this context, the combination data generation means 7 are adapted to generate amplitude combination values which represent an arithmetic mean of the amplitude values of corresponding frequency. The amplitude combination data AKD and the frequency data FD form components of the combination data KN of the combination data packet KP, the combination data KN forming useful data of the combination data packet KP. This has the important advantage that the amount of data of the amplitude combination data is halved as compared with the total amount of data of amplitude data of the two data packets DP1 and DP2.

The information data generation means 6 are adapted to generate combination information data KI, which combination information data KI form a header of the combination data packet KP. In the present context, the information data generation means 6 are adapted to extract the information data of the first data packet DP1 of the two data packets DP1 and DP2 to be combined and to supply said extracted information data to the first joining means 9 as information data I. It is to be noted that it is not strictly necessary to extract the information data from the first data packet DP1. The information data generation means 6 are further adapted to generate and to supply identification data ID to the joining means 9, which identification data ID enable a combination data packet KP to be identified unambiguously as such. Moreover, it is to be noted that the identification data ID may also be adapted to mark the number of combined data packets.

The first reconstruction data generation means 8 are adapted to generate reconstruction data RD with the aid of the two time sequential data packets DP1 and DP1 to be combined and to supply said reconstruction data to the first joining means 9, which reconstruction data RD are adapted to reconstruct the signal from the combination data packets KP. For this purpose, the first reconstruction data generation means 8 are adapted to form amplitude reconstruction data ARD, which are adapted to reconstruct the amplitude values of corresponding frequency of the two time-sequential data packets DP1 and DP2 from the amplitude combination values AKD. As a matter of fact, the reconstruction data generation means 8 are adapted to calculate a first signal energy content value SI1 and a second signal energy content value SI2, represented by the amplitude reconstruction data ARD, the first signal energy content value SI1 representing an energy content of the first signal portion and the second signal energy content value SI2 representing an energy content value of the second signal portion of the signal. The relevant signal energy content value SI1 or SI2 can be calculated as a sum value of the amplitude values, which amplitude values are represented by means of the useful data of the relevant data packet. This has the advantage that in fact the amplitude reconstruction data can be generated in real time. Moreover, the important advantage is obtained that the dynamic signal response and the time resolution of the signal can be reconstructed substantially without any loss of signal quality.

The first joining means are adapted to combine the identification data ID and the information data I to the combination information data KI and to join the frequency data FD and the actuator amplitude combination data AKD as well as the amplitude reconstruction data ARD to the combination data KN. Furthermore, the first joining means are adapted to combine the combination information data KI and the combination data KN to a combination data packet KP and to supply the combination data packet KP to the output terminal 12.

The output means 4 are adapted to receive time sequential combination data packets KP and to supply the data stream DC including the combination data packets KP to the output terminal 5 of output apparatus 1. The output means 4 are realized with the aid of a USB module. The output terminal 5 is realized with the aid of a USB port.

FIG. 7 shows a combination data packet KP of the data stream DC in accordance with the invention, which combination data packet KP can be generated with the aid of the output apparatus 1 shown in FIG. 1. The combination data packet KP is intended for the representation of two time-sequential data packets DP1 and DP2. The combination data packet KP includes the combination information data KI, which form a header of the combination data packet KP. The combination information data KI include the identification data ID, which are adapted to identify the combination data packets KP as such. In addition, the combination information data KI include the information data I which have been extracted from the first data packet DP1 of the two data packets DP1 and DP2 to be combined and which essentially represent the header of the first data packet DP1. The combination data packet KP further includes the combination data KN formed by combining the mutually corresponding useful data of the two time-sequential data packets DP1 and DP2. The combination data KN include the frequency data FD comprised in the first data packet DP1 of the two time-sequential data packets DP1 and DP2. The combination data KN further include amplitude combination data AKD, which represent amplitude combination values, which amplitude combination values have been formed by combining amplitude values of corresponding frequency, the amplitude values of corresponding frequency being represented with the aid of the mutually corresponding useful data of the two time-sequential data packets DP1 and DP2. The amplitude combination values represent arithmetic mean values of the amplitude values of corresponding frequency of the two data packets DP1 and DP2.

The combination data KN further include the reconstruction data RD, which have been formed with the aid of the two time-sequential data packets DP1 and DP2 and which are adapted to reconstruct the signal from the combination data packets KP. The reconstruction data RD have been formed with the aid of the amplitude reconstruction data ARD, which are adapted to reconstruct the amplitude values of corresponding frequency of the two time-sequential data packets DP1 and DP2 from the amplitude combination values. The amplitude reconstruction data ARD represent the two signal energy content values SI1 and SI2, each of the signal energy content values SI1 and SI2 representing an energy content of a signal portion of the signal, which signal portion is represented by means of the respective one of the two data packets DP1 and DP2. Each of the two signal energy content values SI1 and SI2 of a signal portion of the signal takes the form of the sum value of the amplitude values, which amplitude values are represented with the aid of the useful data of the respective data packets DP1 and DP2.

FIG. 2 shows a reproduction apparatus 13, which forms an audio playing apparatus which is adapted to reproduce a signal that can be received with the aid of the data stream DC and which apparatus includes memory means which are not shown in FIG. 2 and which are adapted to store the data stream. The memory means are realized with the aid of a semiconductor memory. The data stream DC can be generated with the aid of the output apparatus 1 shown in FIG. 1.

The reproduction apparatus 13 has an input terminal 14, with the aid of which the data stream DC can be applied to the reproduction apparatus 13. The input terminal 14 is realized with the aid of a USB port. The reproduction apparatus 13 further includes receiving means 15 and signal reconstruction means 16 as well as reproducing means 17.

The receiving means 15 are adapted to receive the data stream DC and are realized with the aid of a USB module. The receiving means 15 further include the semiconductor memory for the storage of the received data stream DC.

The signal reconstruction means 16 are adapted to reconstruct the signal from the combination data packets KP included in the data stream DC. The signal reconstruction means 16 are realized with the aid of software. The signal reconstruction means 16 include first detection means 18 and packet reconstruction means 19 and first amplitude reconstruction means 20 as well as first decompression means 21.

The reproduction apparatus 13 further has a processor circuit which forms a signal reconstruction circuit 22 when the software with the aid of which the signal reconstruction means are formed is run. The signal reconstruction circuit 22 has an input terminal 23, via which the combination data packets KP of the data stream DC can be applied from the receiving means 15 to the signal reconstruction circuit 22. With the aid of the signal reconstruction means 16 the signal reconstruction circuit 22 is adapted to reconstruct the signal from the combination data packets KP included in the data stream DC. The signal reconstruction circuit 22 further has an output terminal 24, via which the signal reconstruction circuit 22 can supply the reconstructed signal S to the reproducing means 17. Thus, with the aid of the signal reconstruction means 16 the reproduction apparatus 13 is adapted to carry out a signal reconstruction process, in which signal reconstruction process the signal is reconstructed from combination data packets KP included in the data stream DC.

The detection means 18 are adapted to detect the combination data packet KP. The detection means 18 are further adapted to extract the amplitude reconstruction data ARD from the combination data packet KP upon detection of the combination data packet KP and to supply the amplitude reconstruction data ARD to the first amplitude reconstruction means 20.

The packet reconstruction means 19 are adapted to receive the combination data packet KP and to reconstruct the two combined data packets DP1 and DP2 from the combination data packet KP and to supply the two reconstructed data packets DP1 and DP2 to the first at reconstruction means 20 as a first reconstructed data packet RDP1 and a second reconstructed data packet RDP2, respectively. For this purpose, the packet reconstruction means 19 are adapted to extract the information data I and the frequency data FD as well as the amplitude combination data AKD from the combination data packet KP. On the basis of said extracted data I, FD and AKD the packet reconstruction means 19 can generate the first reconstructed data packet RDP1 by joining the information data I and the frequency data FD and the amplitude combination data AKD and, in addition, the second reconstructed data packet RDP2 can be generated by duplication of this reconstructed data packet RDP1. Now the identical amplitude combination data AKD present in the first reconstructed data packet RDP1 and in the second reconstructed data packet RDP2 are scalable on the basis of the first signal energy content value SI1 and the second signal energy content value SI2 represented with the aid of the first amplitude reconstruction data ARD. A first scaled data packet SDP1 can be generated by scaling the amplitude combination data AKD of the first reconstructed data packet RDP1 with the aid of the first signal energy content value SI1. A second scaled data packet SDP2 can be generated by scaling the amplitude combination data AKD of the second reconstructed data packet RDP2 with the aid of the second signal energy content value SI1. The scaled data packets SDP1 and SDP2 can be applied from the first amplitude reconstruction means 20 to the first decompression means 21. With the aid of the decompression means 21 the scaled data packets SDP1 and SDP2 can be decompressed in a packet by packet fashion, as a result of which the reconstructed signal S can be generated. The first decompression means 21 are further adapted to supply the reconstructed signal S to the reproducing means 17. The reproducing means 17 are essentially realized with the aid of an amplifier and a loudspeaker.

As a result, the reproduction apparatus 13 has the advantage that the scaled data packets SDP1 and SDP2 represent the combined data packets DP1 and DP2 so accurately that the human ear can detect hardly any difference between the signal recorded on the CD and the signal reconstructed with the aid of the reproduction apparatus 13.

FIG. 3 shows an output apparatus 1 which includes a data source 2 adapted to supply time-sequential data packets, which data packets each represent a signal portion that appears in a given time interval, a first data packet DP1 representing a signal portion which appears in a first time interval and a second data packet DP2 representing a signal portion which appears in a second time interval, which first time interval differs from the second time interval.

The combination means 3 include second reconstruction data generation means 8A which are adapted, not only to generate and to supply the amplitude reconstruction data ARD, but also to generate and to supply time interval reconstruction data DRD, which data are adapted to reconstruct the difference time intervals of the two signal portions of the signal. Thus, the time interval reconstruction data DRD represent a first time interval value T1, which is indicative of a first time interval, and a second time interval value T2, which is indicative of a second time interval. This has the advantage that two data packets DP1 and DP2 which represent signal portions having different lengths of time can be combined, which advantageously extends the range of application of the output apparatus 1.

The combination means 3 further include second joining means 9 adapted to combine the frequency data FD and the amplitude combination data AKD to the combination data KN. The joining means 9 are further adapted to combine the identification data ID and the information data I and the amplitude reconstruction data ARD as well as the time interval reconstruction data DRD to the combination information data KI, as a result of which the combination information data KI include the reconstruction data RD formed by the amplitude reconstruction data ARD and the time interval reconstruction data DRD. The second joining means 9 are further adapted to combine the combination data KN and the combination information data KI to the combination data packet KP. A time sequence of combination data packets KP can be applied as a data stream DC to the output terminal 5 of the output apparatus 1 with the aid of output means 4. This has the advantage that the combination data packet KP includes combination data KN which are free from reconstruction data RD, as a result of which all the information for the reconstruction of the signal is present in the header of the combination data packet KP.

FIG. 8 shows a combination data packet KP that can be generated with the aid of the output apparatus 1 shown in FIG. 3. In the combination data packet KP the combination information data KI are formed by the identification data ID, the information data I, the amplitude reconstruction data ARD and the time interval reconstruction data DRD. Thus, the combination information data KI include reconstruction data RD formed with the aid of the amplitude reconstruction data ARD and the time interval reconstruction data DRD. The combination data KN include the frequency data FD and the amplitude combination data AKD.

FIG. 4 shows a reproduction apparatus 13 which is adapted to reproduce the signal that can be received with the aid of the data stream DC, which data stream DC can be generated by means of the output apparatus 1 shown in FIG. 3.

In the reproduction apparatus 13 shown in FIG. 4 the signal reconstruction means 16 include second detection means 18A, second decompression means 21A, second amplitude reconstruction means 20A and first time interval reconstruction means 25.

The second detection means 18A are adapted to detect a combination data packet KP. In the case of detection the amplitude reconstruction data ARD can be extracted from the combination data packet KP with the aid of the first detection means 18A and can be applied to the first time interval reconstruction means 25. Furthermore, in the case of detection the time interval reconstruction data DRD can be extracted from the combination data packet KP with the aid of the second detection means 18A and can be applied to the time interval reconstruction means 25.

The second decompression means 21A are adapted to receive the combination data packet KP and to decompress the received combination data packet KP. A combination signal KS, which forms the decompression result, can be generated with the aid of the second decompression means 21A and can be applied to the amplitude reconstruction means 20A. The combination signal KS represents the signal for a combination time interval supplied to the reproduction apparatus 13 with the aid of the data stream DC, the combination time interval being the sum of the first time interval and the second time interval.

The first time interval reconstruction means 25 are adapted to supply the first signal energy content value SI1 and the second signal energy content value SI2, represented with the aid of the amplitude reconstruction data ARD, to the second amplitude reconstruction means 20A with the correct time intervals on account of the received amplitude reconstruction data ARD and the time interval reconstruction data DRD. For this purpose, the first time interval reconstruction means 25A include time control means, not shown in FIG. 4. The time control means are essentially realized with the aid of a timer, which can be started to control the supply of the first signal energy content value SI1 to the second amplitude reconstruction means 20A with the correct first time interval value T1. After expiry of the first time interval the timer can be started to supply the second signal energy content value SI2 to the second amplitude reconstruction means 20A with the correct second time interval T2. By virtue of the reception of respective signal energy content value SI1 or SI2 with the correct time interval the second amplitude reconstruction means 20A are adapted to reconstruct the signal amplitude of the first signal portion and of the second signal portion with the correct time intervals, which signal portions are represented with the aid of the two time-sequential data packets DP1 and DP2. The amplitude reconstruction means 20A are adapted to supply the reconstructed signal S as the result of the reconstruction of the signal amplitude.

It is to be noted that the signal reconstruction means 16 may also include overlap means adapted to achieve a time overlap of the signal portions represented with the aid of the combination signal KS. In this context, it is to be noted also that the overlap means may likewise be adapted to achieve a time overlap of time-sequential combination signals. In the technical jargon this overlapping is referred to as “windowing”. The peripheral parts of the signal portions of a signal are then damped in accordance with a weighting function and are superposed in accordance with an overlap time interval. In this context, it is to be noted further that the combination data packets KP forming the data stream DC may include weighting data, which may be generated by means of the output apparatus 1. This has the advantage that the reproduction apparatus 13 can generate different weighting functions with the aid of the overlap means in dependence on the weighting data. Moreover, the advantage is obtained that different overlap time intervals can be generated the aid of the overlap means in dependence on the weighting data. In this context it is to be noted further that the first time interval reconstruction means 25A may be adapted to allow for the overlap time interval. It is to be noted that the overlap means may be arranged, for example, at output side of the second amplitude reconstruction means 20A. However, it has proved to be particularly advantageous if the overlap means are arranged at the input side of the second amplitude reconstruction means 20A. This has the advantage that an optimum time resolution of the signal after the reconstruction is assured in spite of the overlap of signal portions and a consequent reduction of the time resolution of the signal. This is of particularly significance when a comparatively large difference in signal level between the consecutive signal portions is to be reconstructed.

In the output apparatus 1 shown in FIG. 5 the data source 2 is adapted to supply time-sequential data packets, namely a first data packet DP1 and a second data packet DP2, which data packets each represent a signal portion which appears during a time interval, the respective time intervals being identical. The combination means 3 include third reconstruction data generation means 8B and third joining means 9B.

The third reconstruction data generation means 8B are adapted to generate reconstruction data RD which include frequency band dependent amplitude reconstruction data ARD adapted to realize a frequency band dependent reconstruction of the signal amplitude of the signal. The third reconstruction data generation means 8B can thus generate first band scaling data BS1 and second band scaling data BS2, which form the frequency band dependent amplitude reconstruction data ARD. The first band scaling data BS1 represent a first scaling value S1 and a second scaling value S2, the first scaling value S1 serving to reconstruct the signal amplitude in the first time interval and the second scaling value S2 serving to reconstruct the signal amplitude in the second time interval for a first frequency band. The second band scaling data BS2 represent a third scaling value S3 and a fourth scaling value S4, the third scaling value S3 serving to reconstruct the signal amplitude in the first time interval and the fourth scaling value S4 serving to reconstruct the signal amplitude in the second time interval for the second frequency band. The third reconstruction data generation means 8B are further adapted to generate frequency band reconstruction data FRD adapted to reconstruct the first frequency band and the second frequency band. The third joining means 9B are adapted to combine the frequency data FD and the frequency band dependent amplitude reconstruction data ARD and the frequency band reconstruction data FRD as well as the amplitude combination data AKD to the combination data KN, which together with the combination information data KI, which include the identification data ID and the information data I, form a combination data packet KP as shown in FIG. 13.

This has the advantage that the output apparatus 1 can generate a data stream DC in accordance with the invention, which by means of the frequency band dependent amplitude reconstruction data ARD makes it possible to almost completely avoid negative psychoacoustic effects during the reproduction of the signal to be reconstructed from the data stream.

FIG. 13 shows the combination data packet KP of the data stream DC in accordance with the invention, which can be generated with the aid of the output apparatus 1 shown in FIG. 5. The combination data packet KP includes the combination information data KI and the combination data KN, which combination data KN include the reconstruction data RD in addition to the frequency data FD and the amplitude combination data AKD. In the present case, the reconstruction data RD are formed by means of the amplitude reconstruction data ARD and the frequency band reconstruction data FRD.

FIG. 6 shows a reproduction apparatus 13 adapted to reproduce the signal, which signal can be received with the aid of the data stream DC, which can be generated by means of the output apparatus 1 shown in FIG. 5.

In the reproduction apparatus 13 shown in FIG. 6 the signal reconstruction means 16 include third detection means 18B, third amplitude reconstruction means 20B, third data compression means 21B and second time interval reconstruction means 25B. The third amplitude reconstruction means 20B further include first scaling means 26 and second scaling means 27 as well as a summing stage 28.

The third detection means 18B are adapted to detect a combination data packet KP and, upon detection, to extract the amplitude reconstruction data ARD and the frequency band reconstruction data FRD. The third detection means 18B are further adapted to supply the amplitude reconstruction data ARD to the second time interval reconstruction means 25B. Moreover, the third detection means 18B are adapted to supply the frequency band reconstruction data FRD to the third decompression means 21B.

By virtue of the frequency band reconstruction data FRD the third decompression means 21B are adapted to perform a frequency band selective decompression of the combination data packet KP, during which decompression a first combination subband signal KB1 can be generated and supplied to the first scaling means 26 and a second combination subband signal KB2 can be generated and supplied to the second scaling means 27. The first combination subband signal KB1 represents a combination signal during a first combination time interval for the first frequency band, which combination time interval forms the sum of the first time interval and the second time interval of the two signal portions, which signal portions are represented with the aid of the two combined data packets DP1 and DP2. The second combination subband signal KB2 represents a second combination signal during the combination time interval for the second frequency band.

The second time interval reconstruction means 25B are adapted to extract the first band scaling data BS1 and the second band scaling data BS2 from the amplitude reconstruction data ARD and to supply the first band scaling data BS1 and the second band scaling data BS2 to the third amplitude reconstruction means 20B with the correct time intervals. For this purpose, the second time interval reconstruction means 25B in FIG. 6 include time control means, not shown in FIG. 6, which are adapted to start repeatedly with a standard time interval value in synchronism with the decompression of the combination data packet KP, in accordance with the number of combined data packets DP1 and DP2, i.e. in the present case two times. The standard time interval value represents the identical time intervals of the first signal portion and the second signal portion. During the first time interval the second time interval reconstruction means 25B are adapted to apply the first scaling value S1 to the first scaling means 26 and the third scaling value S3 to the second scaling means with the aid of the time control means. Conversely, during the second time interval the second time interval reconstruction means 25B are adapted to apply the second scaling value S2 to the first scaling means 26 and to apply the fourth scaling value to the second scaling means 27 with the aid of the time control means.

The first scaling means 26 are adapted to receive the first combination subband signal KB1 and to scale the first combination subband signal KB1 with the first scaling value S1 which appears with the correct time interval during the first time interval and with the second scaling value S2 which appears with the correct time interval during the second time interval. The first scaling means 26 are then adapted to generate a first subband signal TS1 and to supply the first subband signal TS1 to the summing stage 28.

The second scaling means 27 are adapted to scale the second combination subband signal KP2 with the third scaling value S3 which appears with the correct time interval during the first time interval and with the fourth scaling value S4 which appears with the correct time interval during the second time interval. The second scaling means 26 are then adapted to generate a second subband signal TS2 and to supply the second subband signal TS2 to the summing stage 28. The summing stage 28 is adapted to receive the first subband signal TS1 and the second subband signal TS2 to sum the two subband signals TS1 and TS2 with the correct time scale so as to generate the reconstructed signal S.

It is to be noted that the combination data packet KP may likewise be free from identification data ID.

It is to be noted that the combination data packet KP may likewise represent three or more data packets.

In this context, it is to be noted that the combination means 3 may also be adapted to vary the number of data packets to be combined, in dependence on the dynamic signal response of the respective signal portions.

It is to be noted that in order to supply the data stream DC the output apparatus 1 may have a parallel interface or a serial interface and in order to receive the data stream DC the reproduction apparatus 13 may have such an interface.

It is to be noted that the output apparatus 1 may be adapted to transmit the data stream DC in a contactless manner and the reproduction apparatus 13 may be adapted to receive the data stream DC in a contactless manner in accordance with the Bluetooth standard.

It is to be noted that the output apparatus 1 may also include a data source which may be realized as an interface to the internet, thereby enabling the use of MP3 data packets which are receivable from the internet.

It is to be noted that the reproduction apparatus may also take the form of a CD player or a DVD player.

It is to be noted that both the data reduction circuit 10 of the output apparatus 1 and the signal reconstruction circuit 22 of the reproduction apparatus 13 may be realized as hard-wired circuits, as a result of which the combination means 13 and the signal reconstruction means 16 can be realized without software.

It is to be noted that the reconstruction data RD may be divided between the combination information data KI and the combination data KN.

It is to be noted that the output apparatus 1 may alternatively be adapted to read the compressed signal from a semiconductor memory card.

It is to be noted that the output apparatus 1 may alternatively realized as a set-top box having a data source 2 formed with the aid of a hard disk.

1. A data stream (DC) for transmitting a signal,
which data stream (DC) is derived from the signal by the use of a compression method and which data stream (DC) includes time-sequential data packets which each represent a signal portion appearing during a time interval, characterized in that the data stream (DC) includes combination data packets (KP) which are each intended for the representation of at least two time-sequential data packets (DP1, DP2).

2. A data stream (DC) as claimed in claim 1, characterized in that the combination data packets (KP) include combination data (KN) obtained by combining mutually corresponding useful data of at least two time-sequential data packets (DP1, DP2), and the combination data packets (KP) include reconstruction data (RD) obtained by the use of the at least two time-sequential data packets (DP1, DP2) and adapted to reconstruct the signal from the combination data packets (KP).

3. A data stream (DC) as claimed in claim 2, characterized in that the combination data (KP) include amplitude combination data (AKD) which represent amplitude combination values, which amplitude combination values are obtained by combining mutually corresponding amplitude values, the corresponding amplitude values being represented with the aid of the mutually corresponding useful data of the at least two time-sequential data packets (DP1, DP2).

4. A data stream (DC) as claimed in claim 3, characterized in that the amplitude combination values represent arithmetic mean values of the mutually corresponding amplitude values.

5. A data stream (DC) as claimed in claim 3, characterized in that the combination data (KN) include frequency data included in at least two time-sequential data packets (DP1, DP2).

6. A data stream (DC) as claimed in claim 3, characterized in that the reconstruction data (RD) include amplitude reconstruction data (ARD) adapted to reconstruct the signal amplitudes of at least two signal portions of the signal, which signal portions are represented with the aid of at least two time-sequential data packets (DP1, DP2).

7. A data stream (DC) as claimed in claim 6, characterized in that the reconstruction data (RD) include frequency band dependent amplitude reconstruction data (ARD) adapted to perform a frequency band dependent reconstruction of a signal amplitude.

8. A data stream (DC) as claimed in claim 7, characterized in that the reconstruction data (RD) include frequency band dependent amplitude reconstruction data (FRD) adapted to reconstruct at least one frequency band, which at least one frequency band corresponds to the frequency band dependent amplitude reconstruction data (ARD).

9. A data stream (DC) as claimed in claim 3, characterized in that the reconstruction data (RD) include amplitude reconstruction data (ARD) adapted to reconstruct the mutually corresponding amplitude values of the at least two time-sequential data packets (DP1, DP2) from the amplitude combination values.

10. A data stream (DC) as claimed in claim 2, characterized in that the reconstruction data (RD) include time interval reconstruction data (DRD) adapted to reconstruct the time intervals of the at least two signal portions of the signal, which at least two signal portions are represented with the aid of the at least two data packets (DP1, DP2) represented by the combination data packet (KP).

11. A data stream (DC) as claimed in claim 2, characterized in that the combination data packets (KP) include combination information data (KI), and the combination information data (KI) include the reconstruction data (RD).

12. A data stream (DC) as claimed in claim 11, characterized in that the combination information data (KI) include identification data (ID) adapted to identify a combination data packet (KP).

13. A data stream (DC) as claimed in claim 6, characterized in that the amplitude reconstruction data (ARD) represent signal energy content values, each signal energy content value representing an energy content of a signal portion of the signal, which signal portion is represented by one of the at least two data packets (DP1, DP2).

14. A data stream (DC) as claimed in claim 13, characterized in that the signal energy content value of a signal portion of the signal is formed as a sum value of amplitude values, which amplitude values are represented with the aid of the useful data of the respective data packet (DP1, DP2).

15. An output apparatus (1) for a data stream (DC), which data stream (DC) is derived from the signal by the use of a compression method, the output apparatus
having a data source (2) adapted to generate and to supply data packets (DP1, DP2) which each represent a signal portion appearing during a time interval and which each have an amount of data, and
having data reduction means adapted to reduce the amount of data, and
having output means (4) for the output of the data stream (DC) by the output apparatus (1), characterized in that the data reduction means take the form of combination means (3) which are adapted to combine at least two time-sequential data packets (DP1, DP2) to a combination data packet (KP) and to supply time-sequential combination data packets (KP) to the output means (4).

16. A data reduction method for reducing an amount of data required for transmitting a signal, which method includes the following steps, namely
receiving data packets (DP1, DP2), which data packets (DP1, DP2) each represent a signal portion appearing during a time interval and which each have an amount of data, and
reducing the amount of data, characterized in that during the reduction of the amount of data at least two time-sequential data packets (DP1, DP2) are combined to a combination data packet (KP).

17. A reproduction apparatus (13) adapted to reproduce a signal which can be received with the aid of a data stream (DC), which data stream (DC) is derived from the signal by the use of a compression method, the reproduction apparatus
having receiving means (15) adapted to receive the data stream (DC), and
having signal reconstruction means (16) adapted to reconstruct the signal from the data stream (DC) by the use of a decompression method, and
having reproducing means (17) adapted to reproduce the reconstructed signal (S), characterized in that the signal reconstruction means (16) are adapted to reconstruct the signal from the combination data packets (KP) included in the data stream (DC), which combination data packets (KP) are each intended for the representation of at least two time-sequential data packets (DP1, DP2) which can be generated by the use of the compression method, each data packet (DP1, DP2) representing a signal portion which appears during a time interval.

18. A signal reconstruction method for reconstructing a signal from a data stream (DC), which data stream (DC) is derived from the signal by the use of a compression method, which signal reconstruction method includes the following steps, namely reconstructing the signal from the data stream (DC) by the use of a decompression method, characterized in that the signal is reconstructed from the combination data packets (KP) included in the data stream (DC), which combination data packets (KP) are each intended for the representation of at least two time-sequential data packets (DP1, DP2) which can be generated by the use of the compression method, each data packet (DP1, DP2) representing a signal portion which appears during a time interval.

19. A data reduction circuit (10) for reducing an amount of data required for transmitting a signal, the circuit
having an input terminal (11) via which the data reduction circuit (10) can receive data packets (DP1, DP2) which each represent a signal portion appearing during a time interval, and
having data reduction means adapted to reduce the amount of data, and
having an output terminal (12) via which the data reduction circuit (10) can supply a representation of the received data packets (DP1, DP2), characterized in that the data reduction means take the form of combination means (3) which are adapted to combine at least two time-sequential data packets (DP1, DP2) to a combination data packet (KP) and to supply time-sequential combination data packets (KP) as a representation of the received data packets (DP1, DP2).

20. A signal reconstruction circuit (22) for the reconstruction of a signal from a data stream (DC), which data stream (DC) is derived from a signal by the use of a compression method, the signal reconstruction circuit
having an input terminal (23) via which the data stream data stream (DC) can be applied to the signal reconstruction circuit (22), and
having signal reconstruction means (16) adapted to reconstruct the signal from the data stream (DC) by the use of a decompression method, and
having an output terminal (24) via which the signal reconstruction circuit (22) can supply the reconstructed signal (S), characterized in that the signal reconstruction means (16) are adapted to reconstruct the signal from the combination data packets (KP) included in the data stream (DC), which combination data packets (KP) are each intended for the representation of at least two time-sequential data packets (DP1, DP2) which can be generated by the use of the compression method, each data packet (DP1, DP2) representing a signal portion which appears during a time interval.
